(19) United States
(12) Patent Application Publication
(10) Pub. No.: US 2022/0260963 A1
(43) Pub. Date: Aug. 18, 2022

(54) Selection Controller Artificial Neural Network - SCANN

(71) Applicant: CYBYT LIMITED, South Yorkshire (GB)

(72) Inventor: Anthony Vincent Burpee, Bolsover (GB)

(21) Appl. No.: 17/552,166

(22) Filed: Dec. 15, 2021

Related U.S. Application Data
(60) Provisional application No. 63/126,073, filed on Dec. 16, 2020.

(51) Int. Cl. G05B 19/401; G05B 19/408

(52) U.S. Cl. CPC G05B 19/401; G06N 20/00; G05B 19/4086; G05B 19/4083

(57) ABSTRACT

A method for configuring a selection controller the selection controller to be used for choosing an action to be taken on an item; the method comprising creating a feature map and creating thresholds for association with the nodes on the feature map.

### RELATED APPLICATION

This application claims priority to and incorporates by reference the entirety of U.S. Provisional Application No. 63/126,073, filed on Dec. 16, 2020.

### BACKGROUND

Selection controllers are used to determine the appropriate action to be taken on an item. They do so by analyzing measurements of the item to determine what kind of item the item is. Upon determining the item type, the selection controller can then initiate the appropriate action for an item of that item type.

For example, on a production line, items coming off the production line may be arriving at a high rate, and decisions of which action to take must be taken quickly. Additionally, in a customer call center, the confirmation of statutory compliance is a major rate limiting step in the efficiency and effectiveness of the sales process. Also, in flow cytometry cell sorters, the selection of sub-populations for sorting in either enriched or high purity mode is a major rate limiting step in the efficiency and effectiveness of the discovery process. What would be beneficial in these examples is a selection controller that can use high dimensional data and that is capable of making decisions quickly while allowing the specificity of every decision to be modified accordingly.

The measurements of the item can typically exceed three dimensions. For example, in addition to height, width, and depth, the weight, colour, and transparency may be measured. Each scalar quantity that is measured and analysed adds an extra dimension to the measurement data. The item can then be assigned a point in this multi-dimensional measurement space. The position of the point can be analyzed to determine the item type; however, analyzing high dimensional data is computationally power intensive. This coupled with the requirement for fast paced decision making by the controller presents a problem. Therefore, there is a need for a way to produce selection controllers capable of producing selections based on fast paced analyses of high dimensional data.

### SUMMARY

The present invention in its various aspects is as set out in the appended claims. One embodiment set forth herein provides as follows: A method for configuring a selection controller, the selection controller to be used for choosing an action to be taken on an item; the method comprising:
creating a series of N-dimensional reference points, where each dimension has been converted to a scalar quantity, known as a Feature Map (FM), creating the FM by:
   populating an N-dimensional space with a variable number of starting nodes, the starting nodes each occupying a position in the N-dimensional space; wherein each of the N dimensions are associated with a measurement of the item;
randomly selecting training data that has the same dimensionality as the starting nodes; and
   repositioning the starting nodes to fit the training data to obtain finished nodes; wherein the finished nodes are the repositioned starting nodes; each finished node having a unique identifier;
   obtaining a data set having a plurality of rows of measurements, each row having the same dimensionality as the starting nodes; wherein each row of measurements is associated with a unique item and in each column in the row of measurements is associated with one of the N dimensions and contains the result of a measurement the unique item;
   for each row of the plurality of rows of measurements:
      calculating the distance between the row of measurements and each finished node;
      assigning the row of the plurality of rows of measurements to a best matching unit, BMU, wherein the BMU is the finished node closest to the row of measurements;
      recording the unique identifier of the finished node associated with the best matching unit and the distance between the row of measurements and the best matching unit, wherein the distance between the row of measurements and the best matching unit is the feature map item distance, FMID, and
      for each of the N dimensions:
      determining the distance between column of the row of measurements associated with the dimension and the position of the BMU in the dimension;
   for each finished node:
      in each of the N dimensions;
      creating a threshold for association with the BMU in the dimension; and associating the unique identifier of each finished node in the system with one action of a plurality of actions;
configuring the controller to determine what action should be taken on an item by obtaining a row of measurements associated with the item, the row of measurements having the same dimensionality as the starting nodes, associating the row of measurements with a BMU; and determining that the action associated with the unique identifier of the BMU should be taken.

### BRIEF DESCRIPTION OF THE DRAWINGS

FIG. 1 discloses a framework 100 according to an embodiment of the present invention.

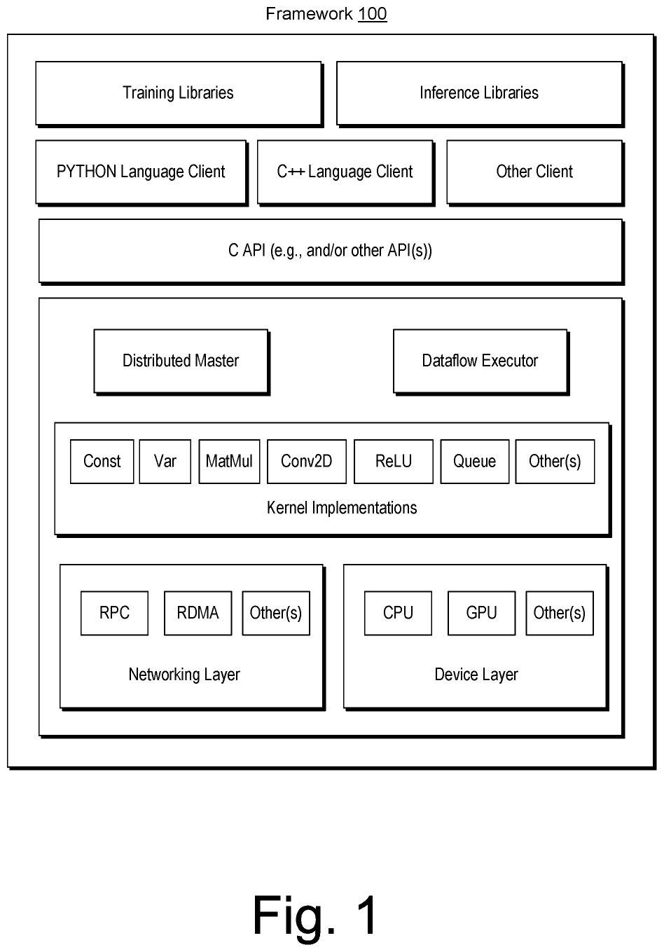

FIG. 2 shows the system components 200 and a network system 210 according to an embodiment of the present invention. The system components are a processor 202 in communication with a bus 208, a memory/storage 204 in communication with the same bus 208, and an I/O device 206 in communication with the bus 208. The Network system 210 shows a network 220 of components 222-1 to 222-N.

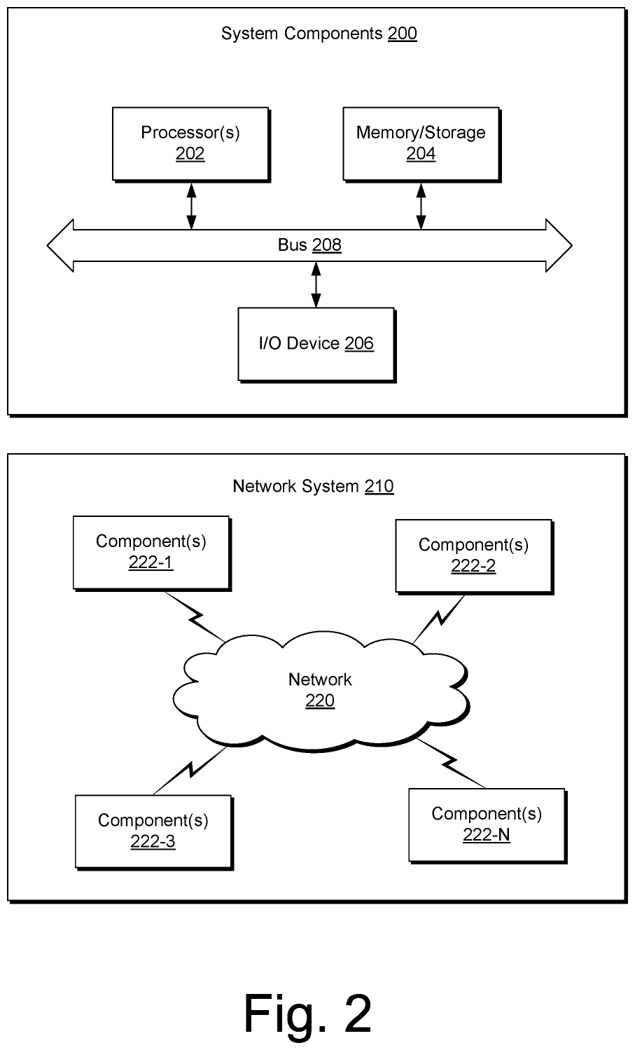

### DESCRIPTION

The present invention provides a method for configuring a selection controller, the selection controller to be used for choosing an action to be taken on an item. One embodiment of the method comprises:

Creating a feature map FM by populating an N-dimensional space with a variable number of starting nodes, the starting nodes each occupying a position in the N-dimensional space. Here N is a positive integer and is equal to the number of dimensions in the N-dimensional space. Each of the N dimensions are associated with a measurement of the item, the measurement having been converted to a scalar value. Each measurement of the item is a scalar quantity. As such, the item can be represented as a point in the N dimensional space. The feature map is generated algorithmically and is preferably a self-organising feature map (SOFM)

Next, training data is randomly selected. The training data has the same dimensionality as the starting nodes. The starting nodes are repositioned to fit the training data to obtain finished nodes, wherein the finished nodes are the repositioned starting nodes. Each finished node is assigned a unique identifier. During the repositioning step, the starting nodes may be referred to as training nodes. After the finished nodes are obtained, the FM has been created. The starting nodes are repositioned such that the finished nodes best fit the training data. And as such the controller will be able to distinguish between different types of item when in use. Repositioning the nodes may be done using an unsupervised learning algorithm, preferably a competitive learning algorithm.

The number of starting nodes may be equal to 2^{N}/2. This initial choice is based on bimodal populations, where N=1 there would be 2 populations, where N=2 there would be 4, 3 is 8, 4 is 16, etc.

The method further comprises obtaining a data set having a plurality of rows of measurements and for each row of the plurality of rows of measurements passing the data set through the FM. Passing the data set through the FM comprises assigning the row of the plurality of rows of measurements to a best matching unit, BMU, and recording the unique identifier of the finished node associated with the best matching unit.

A BMU is the finished node that is closest to the row of measurements in the N dimensional space. Closest here means the shortest distance. Therefore, the finished node that has the shortest distance to the row of measurements in the N-dimensional space is chosen as the BMU for the row of measurements.

Each row of measurements has the same dimensionality as the finished nodes so that the distance between each row of measurements and the finished nodes can be determined.

The starting nodes and training data may be selected at random from one or more larger data sets. The one or more data sets may have a higher dimensionality than the starting nodes. The starting nodes may be obtained by selecting, at random, a number of rows of a larger data set, the number of rows selected being equal to the number of starting nodes, and of those selected rows, selecting N columns. Each column relates to one of the N dimensions.

Similarly, the training data may be obtained by selecting, at random, a number of rows of measurements from one or more larger data sets, the number of rows selected being equal to the number of training data, and of those selected rows, selecting the same N columns as for the starting nodes to ensure that the training data and the starting nodes have the same dimensionality.

The starting nodes and training data are preferably taken form the same larger data set but may be taken from different larger data sets.

The step of obtaining a data set may be achieved by selecting all of the rows of a larger data set and selecting the same N columns as for the starting nodes to ensure that the data set and the finished nodes have the same dimensionality.

The starting nodes, training data and data set are preferably taken from the same larger data set but may be taken from different larger data sets.

The method may further include, after passing the data set through the FM, preferably with 2^{N}/2 starting nodes, iteratively repeating the creation of the FM using a different number of starting nodes to optimize the FM for speed and accuracy, accuracy here referring to how well the FM partitions the training data. After the creation of each new FM, the data set will be passed through the FM so that it can be determined if the most recent iteration of the FM is an improvement on the last. The choice of the number of starting nodes in each iteration may be made using a bisection algorithm such as the one disclosed in Knuth, Donald “Sorting and searching. The Art of Computer Programming,” 3 (2nd ed.). Reading, Mass.: Addison-Wesley Professional, 1998, ISBN 978-0-201-89685-5. Iteratively varying the number of starting nodes in this way ensures that the data passed through the FM is being partitioned accurately; if too few starting nodes are used, the differences between rows of measurements (items) will not be determined accurately by the FM as there are not enough categories (finished nodes) for the item to be classified as. On the so other hand, if too many starting nodes are used, it may be the case that the additional starting nodes are not providing any significant improvement in accuracy but are increasing the number of computations required on each row of measurements analyzed by the selection controller. If the step of iteratively repeating the creation of the FM using a different number of starting nodes to optimize the FM for speed and accuracy is implemented, the resulting optimized FM will be used for the remainder of the method.

Alternatively, to iteratively repeat the creation of the FM using a different number of starting nodes, the method may further include iteratively repeating the creation of the FM using a different number of dimensions to optimize for speed and accuracy. The choice of the number of starting nodes in each iteration may be made using a bisection algorithm such as the one disclosed in Knuth, Donald, “Sorting and searching. The Art of Computer Programming,” 3 (2nd ed.). Reading, Mass.: Addison-Wesley Professional, 1998, ISBN 978-0-201-89685-5. It may be the case that one or more of the N dimensions considered in the first FM created do not impact the quality of the data partitioning and therefore that their inclusion in the FM is increasing the number of computations required for each row of measurements analysed by the selection controller without providing any benefit in terms of improved partitioning. Further, there may be a dimension that was not considered in the first FM that, if considered would provide greatly improved partitioning. If the step of iteratively repeating the creation of the FM using a different number of dimensions to optimize the FM for speed and accuracy is implemented, the resulting optimized FM will be used for the remainder of the method.

To achieve the most accurate FM the method may include both iteratively repeating the creation of the FM using a different number of starting nodes and iteratively repeating the creation of the FM using a different number of dimensions to optimize for speed and accuracy. In this case, if both steps are implemented, the resulting optimized FM will be used for the remainder of the method. It is preferable that the number of starting nodes is optimized in before the number of dimensions. Iterating through the starting nodes is computationally less demanding than iterating through the number of dimensions. Optimizing the number of starting nodes first therefore uses less computing power as the FM that is optimized for the number of dimensions is already partially optimized.

The method further comprises iteratively analyzing the distance between each row of measurements and the BMU in the FM to determine the distance of each row of measurements from its closest BMU.

The method further comprises calculating the N-dimensional distance between each row of measurements and their respective BMUs in the FM and recording that information on a per row basis, FMID.

The method further comprises, for each BMU, in each of the N dimensions and the FMID, creating a threshold for association with the BMU. This step results in N+1 thresholds for association with each BMU, one in each dimension plus the FMID. The threshold in each measurement may comprise an upper threshold and a lower threshold. In any given measurement, the upper threshold and lower threshold are above and below the position of the BMU in the given measurement. Creating a threshold for association with each BMU prevents incorrect classification of an item.

Creating a threshold for association with each BMU comprises in each of the N dimensions:

for each dimension: building a binned frequency distribution histogram of the distance for each item to the BMU; calculating the maximum measured distance from the BMU to any associated row above the BMU; setting the upper threshold to a number which is a fraction of that distance; and calculating the maximum measured distance from the BMU to any associated row below the BMU; and setting the lower threshold to a number which is a fraction of that distance.

Each finished node may further be associated with one of a plurality of item classes, an item class defining a range of values the measurements of a given item must be within in order for the item to be associated with the item class. The plurality of item classes may be stored in a separate database. The upper and lower thresholds, the fractions can therefore be set such that each row of measurements positioned between the threshold and the BMU are associated with the item class. This ensures that the action associated with the BMU will only be carried out on items that are within the item class associated with the BMU. This is beneficial as every row of measurements can be assigned to a BMU as a BMU is simply the closest finished so node to the row of measurements. It is possible however that the row of measurements is an outlier in that it is very far from any of the finished nodes in the FM such that none of the actions associated with the finished nodes would be appropriate, i.e., the item described by the row of measurements does not fall into any of the item classes. Defining the item class and using the item class to define the thresholds ensures that outliers will not have an incorrect action taken on them.

Further, associating each node with an item class in this way cross references the finished nodes, which arise from unsupervised partitioning of training data, with measurables in the real world. An optional, but important aspect of implementation of the present invention is that if the trained dataset does not identify a single item class for a given node, for example a plurality of item classes per node then the training should be repeated with a greater number of nodes so as to enable item classes to be properly differentiated based upon a single node. A further, optional, but important aspects of implantation of the present invention is therefore that if more than one node only identifies a single item class the training should be repeated with a fewer number of nodes so as to enable item classes to be efficiently identified.

An item class is preferably a single object. An example of a single object item class is a biological cell, for example a blood cell.

The method further comprises associating the unique identifier of each finished node in the system with an action. When the controller is in use, if a row of measurements is within the threshold of its best matching unit in each of the N dimensions then the action will be performed on an item associated with the row of measurements. The controller may be configured to define a null action, the null action being the action that is carried out if the row of measurements is not associated with a BMU.

The controller may define a null node in the N dimensional space. The Null node is associated with the null action. Any row of measurements that is not associated with the BMU is associated with the null node. This allows a user to check which rows of measurements are in the null node, i.e., which items have had the null action taken on them. This may be beneficial because, in the example of a postal sorting office, with the actions being sending an item of mail to another location, even the items that cannot be characterised still need to be sent. The null action could therefore be sending the items to a human operative for sorting.

The method further comprises configuring the controller to determine what action should be taken on an item by obtaining a row of measurements associated with the item, the row of measurements having the same dimensionality as the starting nodes, associating the row of measurements with a BMU; and determining that the action associated with the unique identifier of the BMU should be taken.

Associating the row of measurements with a BMU to determine the appropriate action for the item may preferably comprise: determining the distance between the row of measurements and every finished node, determining which finished node is closest to the row of measurements; comparing the row of measurements to the threshold for association with the finished node each of the N dimensions; and if the row of measurements is between the threshold and the BMU in each of the N dimensions, then the selection controller assigning the closest finished node as the BMU for the row of measurements and initiating the action associated with the unique identifier BMU; if the row of measurements lies outside of the threshold in any or all of the N dimensions, the selection controller initiates a null action. A null action may be taking no action at all. A null action may alternatively be any action appropriate for an item that cannot be assigned to a BMU, disposal for example. This method of determining the appropriate action for an item is preferable when precision is of the upmost importance. An example scenario of when this precise method of determining the correct action to be taken may be needed is in sorting parcels for shipping globally. The actions in this case would be shipping a package to a given country. The costs of shipping an item to the wrong country are high and each item typically must be shipped so the number of null actions should be minimized.

The speed of decision making could be improved by clustering finished nodes. To provide this improvement in speed, the controller may alternatively be configured to: for each action of the plurality of actions, assigning the action a number from 1 to n with n being the number of actions, and associating each action with a cluster of finished nodes, the cluster of finished nodes being all of the finished nodes being associated with that action. Then associating the row of measurements with a BMU to determine the appropriate action for the item comprises: in an iteration through each of the plurality of actions starting with the first action, determining the distance between the row of measurements and each finished node in the cluster associated so with the action, determining which finished node in the cluster is closest to the row of measurements, comparing the row of measurements to the threshold for association with the closest finished node in each of the N dimensions, and if the row of measurements is between the threshold and the BMU in each of the N dimensions, then the selection controller assigning the closest finished node as the BMU for the row of measurements and initiating the action associated with the unique identifier BMU. If the row of measurements is not within threshold for association with the BMU in each of the N dimensions, checking the next action. If the row of measurements is not within threshold for association with the BMU in each of the N dimensions for any action, determining that a null action should be taken.

Alternatively, if speed of decision making is the most important factor to consider, for example in flow cytometry where half a million decisions per second need to be made at the cells are passing through the tube at a high speed (up to 15 metres per second). Associating the row of measurements with a BMU to determine the appropriate action for the item may then require the controller be further configured to: for each action of the plurality of actions, defining a range for association with the action in each of the N dimensions; and assign the action a number from 1 to n with n being the number of actions. Then associating the row of measurements with a BMU to determine the appropriate action for the item comprises: in an iteration through each of the plurality of actions starting with the first action, determining, for each of the N dimensions whether the row of measurements is within the range for association with the action; If the row of measurements is within the range for association with the action, determining the distance between the row of measurements and every finished node, determining which finished node is closest to the row of measurements, comparing the row of measurements to the threshold for association with the finished node in each of the N dimensions, and if the row of measurements is between the threshold and the BMU in each of the N dimensions, then the selection controller assigning the closest finished node as the BMU for the row of measurements and initiating the action associated with the unique identifier BMU. If the row of measurements is not within the range for association with the action, checking the next action. If the row of measurements is not in within the range for association with action for any action, determining that a null action should be taken.

To further increase the speed of decision making, in addition to the controller being configured to: for each action of the plurality of actions, defining a range for association with the action in each of the N dimensions; and assign the action a number from 1 to n with n being the number of actions, the controller may be further configured to associate each action with a cluster of finished nodes, the cluster of finished nodes being all of the finished nodes being associated with that action. Then associating the row of measurements with a BMU to determine the appropriate action for the item comprises: In an iteration through each of the plurality of actions starting with the first action, determining, for each of the N dimensions whether the row of measurements is within the range for association with the action. If the row of measurements is not within the range for association with the action, checking the next action. If the row of measurements is not in within the range for association with action for any action, determining that a null action should be taken. If the row of measurements is within the range for association with the action, determining the distance between the row of measurements and each finished node in the cluster associated with the action, determining which finished node in the cluster is closest to the row of measurements; comparing the row of measurements to the threshold for association with the finished node in each of the N dimensions; and if the row of measurements is between the threshold and the closest finished node in each of the N dimensions, then the selection controller assigning the closest finished node as the BMU for the row of measurements and initiating the action associated with the unique identifier BMU.

All of the above considered methods for associating the row of measurements with a BMU to determine the appropriate action for the item share the benefit of the fact that they only require the use of simple arithmetic (Pythagoras theorem) to determine the best matching unit. This is beneficial as it allows the present invention to associate a row of measurements with a BMU and therefore take an action quickly and efficiently.

The selection controller may be configured on a processor, and used on a processor. It is not a requirement that the processor that the controller is configured on is the same as the processer that runs the configured controller. For example, in the field of flow cytometry, the FM may be configured on a workstation computer and then the configured FM may be uploaded to a cell sorter so that the cell sorter can use the configured FM to sort cells.

In another aspect, the present invention provides a selection controller configured in the manner set out above.

The selection controller configured to take as input a row of measurements, each row of measurements having the same dimensionality as the finished nodes. The selection controller configured to determine a Best Matching Unit for the row of measurements, BMU, the BMU being the finished node that is closest to the row of measurements in the N dimensional space.

The selection controller is further configured to compare the row of measurements to the threshold for association with the BMU in each of the N dimensions.

If the row of measurements is between the threshold and the BMU in each of the N dimensions, then the selection controller assigns the row of measurements to the BMU and initiates the action associated with the BMU.

If the row of measurements lies outside of the threshold in any or all of the N dimensions, the selection controller does not initiate any action.

For a row of measurements that lies outside of the threshold of the BMU, the controller may assign the row of measurements a status of “don't know” to indicate that the row of measurements could not be assigned to any BMU and that therefore the appropriate action is not known.

Here the benefit of the present invention is clear, a row of measurements may always be determined to be closest to a given node in the system, even if in reality it is simply very far from all the nodes. To prevent incorrect actions being taken on rows of measurements that are too far from the BMU, the threshold for association with each BMU is created.

In the context of the present invention, being too far from the BMU can be related to not being associated with an ITEM class.

The selection controller is preferably configured to take as input one row of measurements at a time such that the selection controller analyzes a row of measurements and instigates the appropriate action before analyzing another row. It should be noted that due to the fact that only simple arithmetic is used to determine if a row of data can be assigned to a best matching unit, this process can happen on a very fast timescale.

The selection controller may be configured within a system having one or more sensors, the one or more sensors each taking one or more measurements of an item. Each measurement of the item corresponds to one of the N dimensions.

### Use Cases

Cytometry

The selection controller may be configured to determine the type of cells passing through a flow cytometry system. In this case, each of the N dimensions may be a measure of an intensity of a type of protein present on the surface of the cell and therefore each row of measurements contains N measurements of intensity of different proteins.

Cell sorters are sensitive devices which require continual monitoring, this FM method provides a means to evaluate all cell populations providing an early indicator of any instrument instability saving valuable sample from being poured into the drain.

Additionally, complex N dimensional cell type definitions are needed to sort cells, but these definitions are time consuming to construct and difficult to refine. This method provides a way to rapidly and define the cells of interest and allows that definition to be fine-tuned to sort the cells of interest.

Production Line

The selection controller may be configured to sort items in a production line. In this case each row of measurements contains measurements of an item on the production line, for example height, weight, depth, length, colour. The actions therefore may be to either allow the item to continue on the production line or to remove the item if the item does not conform to the desired measurements in one or more of the dimensions.

Voice Analytics and Statutory Compliance

Organizations throughout the world face complex regulations. With an increasing number of regulations, the burden to understanding, managing, and gaining insight from voice data is more important than ever in areas such as Compliance, Risk Management, Regulatory Intelligence, Regulatory Reporting and Fraud Detection.

While the use of voice analytics has become increasingly prevalent in regulated businesses, the ability to generate and action real-time change from key business insights has lagged significantly. By coupling FM with voice analytics high dimension data, over 500 different measurements per second, it is possible to help ensure that business employees can be prompted in real-time to meet their statutory obligations while talking with clients dynamically improving overall compliance. A plurality of FM systems keyed on core compliance issues can be used to help ensure that each interaction with clients has the best chance of soft-landing a compliant interaction.

The following is a list of embodiments:

Embodiment 1: A method for configuring a selection controller, the selection controller to be used for choosing an action to be taken on an item; the method comprising:

creating a series of N-dimensional reference points, where each dimension has been converted to a scalar quantity, known as a Feature Map (FM), creating the FM by:

populating an N-dimensional space with a variable number of starting nodes, the starting nodes each occupying a position in the N-dimensional space; wherein each of the N dimensions are associated with a measurement of the item;

so randomly selecting training data that has the same dimensionality as the starting nodes; and

repositioning the starting nodes to fit the training data to obtain finished nodes;

wherein the finished nodes are the repositioned starting nodes; each finished node having a unique identifier;

obtaining a data set having a plurality of rows of measurements, each row having the same dimensionality as the starting nodes; wherein each row of measurements is associated with an unique item and in each column in the row of measurements is associated with one of the N dimensions and contains the result of a measurement the unique item;

for each row of the plurality of rows of measurements:
calculating the distance between the row of measurements and each finished node;

assigning the row of the plurality of rows of measurements to a best matching unit, BMU, wherein the BMU is the finished node closest to the row of measurements;

recording the unique identifier of the finished node associated with the BMU and the distance between the row of measurements and the BMU, wherein the distance between the row of measurements and the BMU is the feature map item distance, FMID, and

for each of the N dimensions:

determining the distance between column of the row of measurements associated with the dimension and the position of the BMU in the dimension;

for each finished node:

in each of the N dimensions; creating a threshold for association with the BMU in the dimension;

associating the unique identifier of each finished node in the system with one action of a plurality of actions;

configuring the controller to determine what action should be taken on an item by obtaining a row of measurements associated with the item, the row of measurements having the same dimensionality as the starting nodes, associating the row of measurements with a BMU; and determining that the action associated with the unique identifier of the BMU should be taken.

Embodiment 2: The method of any preceding embodiment wherein: during the repositioning step the nodes are referred to as training node

Embodiment 3: The method of any preceding embodiment wherein the starting nodes and training data are extracted from a larger data set.

Embodiment 4: The method of embodiment 1 wherein the starting nodes are positioned at random in the N dimensional space.

Embodiment 5: The method of any preceding embodiment wherein the distance between the row of measurements and each finished node is calculated as a Euclidian distance.

Embodiment 6: The method of any of embodiments 1 to 4 wherein the distance between the row of measurements and each finished node is calculated as a Manhattan distance.

Embodiment 7: The method of any of embodiments 1 to 4 wherein the distance between the row of measurements and each finished node is calculated as a Minkowski distance.

Embodiment 8: The method of any preceding embodiment wherein the number of starting nodes is between 2 and 2″.

Embodiment 9: The method of any preceding embodiment wherein the number of starting nodes is 2.

Embodiment 10: The method of any of embodiments 1 to 8 wherein the number of starting nodes is equal to 2^{N}/2.

Embodiment 11: The method of any preceding embodiment wherein, after the step of recording the number of the node associated with the best matching unit; the method further comprises iteratively repeating the step of creating a feature map (FM) using a new variable number of nodes for each iteration; and selecting the FM that is the best fit for the data set; wherein the FM that best fits the data set is used for the remainder of the method.

Embodiment 12: the method of embodiment 11, wherein selecting the FM that is the best fit for the data set comprises selecting the FM that has the smallest chi squared distance from the data set.

Embodiment 13: The method of embodiment 11 or embodiment 10, wherein in each iteration, the number of starting nodes is varied.

Embodiment 14: The method of any preceding embodiment wherein for each BMU, the threshold for association with the BMU in the dimension comprises an upper threshold and a lower threshold, and creating a threshold for association with the BMU in the dimension comprises in each of the N dimensions comprises:
building a binned frequency distribution histogram of the distance for each item to the BMU;
calculating the maximum measured distance from the BMU to any associated row above the BMU; and setting the upper threshold to a number which is a fraction of that distance; and
calculating the maximum measured distance from the BMU to any associated row below the BMU; and setting the lower threshold to a number which is a fraction of that distance.

Embodiment 15: The method of embodiment 14 wherein each finished node is associated with an item class, the item class defining a range of values the measurements of a given item must be within in order for the item to be associated with the item class;

for the upper and lower thresholds, the fractions are set such that each row of measurements positioned between the threshold and the BMU are associated with the item class.

Embodiment 16: The method of any preceding embodiment, wherein associating the row of measurements with a BMU to determine the appropriate action for the item comprises:

determining the distance between the row of measurements and every finished node, determining which finished node is closest to the row of measurements;

comparing the row of measurements to the threshold for association with the finished node each of the N dimensions; and

if the row of measurements is between the threshold and the BMU in each of the N dimensions, then the selection controller assigning the closest finished node as the BMU for the row of measurements and initiating the action associated with the unique identifier BMU;

if the row of measurements lies outside of the threshold in any or all of the N dimensions, the selection controller initiates a null action.

Embodiment 17: The method of any of embodiments 1 to 15 wherein the controller is further configured to, for each action of the plurality of actions, defining a range for association with the action in each of the N dimensions;

and wherein associating the row of measurements with a BMU to determine the appropriate action for the item comprises:

iterating through each of the plurality of actions;

determining, for each of the N dimensions whether the row of measurements is within the range for association with the action;

If the row of measurements is within the range for association with the action, determining the distance between the row of measurements and every finished node, determining which finished node is closest to the row of measurements;

comparing the row of measurements to the threshold for association with the finished node each of the N dimensions; and

if the row of measurements for the item is between the upper and lower threshold and the BMU in each of the N dimensions, then the selection controller assigning the closest finished node as the BMU for the row of measurements and initiating the action associated with the unique identifier BMU;

If the row of measurements is not within the range for association with the action, checking the next action;

if the row of measurements is not in within the range for association with action for any action, determining that a null action should be taken.

Embodiment 18: The method of any of embodiments 1 to 15 wherein for each finished node in the FM, the method further comprises creating a FMID threshold;

wherein the FMID threshold is a distance from the finished node; and

wherein associating the row of measurements with a BMU to determine the appropriate action for the item comprises:

determining the distance between the row of measurements and every finished node, determining which finished node is closest to the row of measurements;

comparing the row of measurements to the threshold for association with the closest finished node in each of the N dimensions; and

comparing the FMID of the row of measurements to the FMID threshold of the closest finished node;

if the row of measurements is between the threshold and the finished node in each of the N dimensions, and if the FMID of the row of measurements is between the FMID threshold of the closest finished node, the selection controller assigning the closest finished node as the BMU for the row of measurements and initiating the action associated with the unique identifier BMU;

if the row of measurements lies outside of the threshold in any or all of the N dimensions, and or outside of the FMID threshold, the selection controller initiates a null action.

Embodiment 19: The method of any of embodiments 1 to 15 wherein for each finished node in the FM, the method further comprises creating a FMID threshold;

wherein the FMID threshold is a distance from the finished node; and

wherein the controller is further configured to, for each action of the plurality of actions, defining a range for association with the action in each of the N dimensions;

and wherein associating the row of measurements with a BMU to determine the appropriate action for the item comprises:

iterating through each of the plurality of actions;

determining, for each of the N dimensions whether the row of measurements is within the range for association with the action;

if the Row of measurements is within the range for association with the action, determining the distance between the row of measurements and every finished node, determining which finished node is closest to the row of measurements;

comparing the row of measurements to the threshold for association with the finished node each of the N dimensions; and

comparing the FMID of the row of measurements to the FMID threshold of the closest finished node;

if the row of measurements for the item is between the upper and lower threshold and the BMU in each of the N dimensions, and if the FMID of the row of measurements is between the FMID threshold of the closes finished node, then the selection controller assigning the closest finished node as the BMU for the row of measurements and initiating the action associated with the unique identifier BMU;

If the row of measurements is not within the range for association with the action, checking the next action;

if the row of measurements is not in within the range for association with action for any action, determining that a null action should be taken;

Embodiment 20: The method of any preceding embodiment wherein, for each finished node, the selection controller is configured to present a user with an option for the selection controller to not consider one or more of the FMID threshold or one or more of the thresholds for association with the finished node in the N dimensions.

Embodiment 21: The method of any preceding embodiment wherein the FM a self-organizing feature map (SOFM).

Embodiment 22: The method of any preceding embodiment wherein the selection controller is configured to, when in use, record the determined action for each row of measurements.

Embodiment 23: The method of any preceding embodiment wherein the method further comprises configuring the selection controller to, when in use to monitor the percentage of rows of measurements that are being associated with each finished node within a quantized time period; and

comparing the percentages to the percentages of rows of measurements assigned to each finished node during configuration.

Embodiment 24: The method of any preceding embodiment wherein the selection controller is further configured to calibrate the conversion of scalar quantities.

Embodiment 25: A selection controller configured as per any of the preceding embodiments.

1. A method for configuring a selection controller, the selection controller to be used for choosing an action to be taken on an item, the method comprising:
creating a series of N-dimensional reference points, where each dimension has been converted to a scalar quantity, known as a Feature Map (FM), creating the FM by:
populating an N-dimensional space with a variable number of starting nodes, the starting nodes each occupying a position in the N-dimensional space; wherein each of the N dimensions are associated with a measurement of the item;
randomly selecting training data that has the same dimensionality as the starting nodes; and
repositioning the starting nodes to fit the training data to obtain finished nodes; wherein the finished nodes are the repositioned starting nodes; each finished node having a unique identifier;
obtaining a data set having a plurality of rows of measurements, each row having the same dimensionality as the starting nodes;
wherein each row of measurements is associated with an unique item and in each column in the row of measurements is associated with one of the N dimensions and contains the result of a measurement the unique item;
for each row of the plurality of rows of measurements:
calculating the distance between the row of measurements and each finished node;
assigning the row of the plurality of rows of measurements to a best matching unit, BMU, wherein the BMU is the finished node closest to the row of measurements;
recording the unique identifier of the finished node associated with the BMU and the distance between the row of measurements and the BMU, wherein the distance between the row of measurements and the BMU is the feature map item distance, FMID; and
for each of the N dimensions:
determining the distance between column of the row of measurements associated with the dimension and the position of the BMU in the dimension;
for each finished node:
in each of the N dimensions; creating a threshold for association with the BMU in the dimension;
associating the unique identifier of each finished node in the system with one action of a plurality of actions;
configuring the controller to determine what action should be taken on an item by obtaining a row of measurements associated with the item, the row of measurements having the same dimensionality as the starting nodes, associating the row of measurements with a BMU; and determining that the action associated with the unique identifier of the BMU should be taken.

2. The method of claim 1, wherein: during the repositioning step the nodes are referred to as training nodes.

3. The method of claim 1, wherein the starting nodes and training data are extracted from a larger data set.

4. The method of claim 1, wherein the starting nodes are positioned at random in the N dimensional space.

5. The method of claim 1, wherein the distance between the row of measurements and each finished node is calculated as one of a Euclidian distance, a Manhattan distance, or a Minkowski distance.

6. The method of claim 1, wherein the number of starting nodes is between 2 and 2^{N}.

7. The method of claim 1, wherein the number of starting nodes is 2.

8. The method of claim 1, wherein the number of starting nodes is equal to 2^{N}/2.

9. The method of claim 1, wherein, after the step of recording the number of the node associated with the best matching unit, the method further comprises:
iteratively repeating the step of creating a feature map (FM) using a new variable number of nodes for each iteration; and
selecting the FM that is the best fit for the data set, wherein the FM that best fits the data set is used for the remainder of the method.

10. the method of claim 9, wherein selecting the FM that is the best fit for the data set comprises selecting the FM that has the smallest chi squared distance from the data set.

11. The method of claim 9, wherein in each iteration, the number of starting nodes is varied.

12. The method of claim 1, wherein for each BMU, the threshold for association with the BMU in the dimension comprises an upper threshold and a lower threshold, and creating a threshold for association with the BMU in the dimension comprises in each of the N dimensions comprises:
building a binned frequency distribution histogram of the distance for each item to the BMU;
calculating the maximum measured distance from the BMU to any associated row above the BMU; and setting the upper threshold to a number which is a fraction of that distance; and
calculating the maximum measured distance from the BMU to any associated row below the BMU; and setting the lower threshold to a number which is a fraction of that distance.

13. The method of claim 12, wherein each finished node is associated with an item class, the item class defining a range of values the measurements of a given item must be within in order for the item to be associated with the item class;
for the upper and lower thresholds, the fractions are set such that each row of measurements positioned between the threshold and the BMU are associated with the item class.

14. The method of claim 1, wherein associating the row of measurements with a BMU to determine the appropriate action for the item comprises:
determining the distance between the row of measurements and every finished node, determining which finished node is closest to the row of measurements;
comparing the row of measurements to the threshold for association with the finished node each of the N dimensions; and
if the row of measurements is between the threshold and the BMU in each of the N dimensions, then the selection controller assigning the closest finished node as the BMU for the row of measurements and initiating the action associated with the unique identifier BMU;
if the row of measurements lies outside of the threshold in any or all of the N dimensions, the selection controller initiates a null action.

15. The method of claim 1, wherein the controller is further configured to, for each action of the plurality of actions, defining a range for association with the action in each of the N dimensions;
and wherein associating the row of measurements with a BMU to determine the appropriate action for the item comprises:
iterating through each of the plurality of actions;
determining, for each of the N dimensions whether the row of measurements is within the range for association with the action;
If the row of measurements is within the range for association with the action, determining the distance between the row of measurements and every finished node, determining which finished node is closest to the row of measurements;
comparing the row of measurements to the threshold for association with the finished node each of the N dimensions; and
if the row of measurements for the item is between the upper and lower threshold and the BMU in each of the N dimensions, then the selection controller assigning the closest finished node as the BMU for the row of measurements and initiating the action associated with the unique identifier BMU;
If the row of measurements is not within the range for association with the action, checking the next action;
if the row of measurements is not in within the range for association with action for any action, determining that a null action should be taken.

16. The method of claim 1, wherein for each finished node in the FM, the method further comprises creating a FMID threshold, wherein the FMID threshold is a distance from the finished node; and
wherein associating the row of measurements with a BMU to determine the appropriate action for the item comprises:
determining the distance between the row of measurements and every finished node, determining which finished node is closest to the row of measurements;
comparing the row of measurements to the threshold for association with the closest finished node in each of the N dimensions; and
comparing the FMID of the row of measurements to the FMID threshold of the closest finished node;
if the row of measurements is between the threshold and the finished node in each of the N dimensions, and if the FMID of the row of measurements is between the FMID threshold of the closes finished node, the selection controller assigning the closest finished node as the BMU for the row of measurements and initiating the action associated with the unique identifier BMU;
if the row of measurements lies outside of the threshold in any or all of the N dimensions, and or outside of the FMID threshold, the selection controller initiates a null action.

17. The method of claim 1, wherein for each finished node in the FM, the method further comprises creating a FMID threshold, wherein the FMID threshold is a distance from the finished node; and
wherein the controller is further configured to, for each action of the plurality of actions, defining a range for association with the action in each of the N dimensions;
and wherein associating the row of measurements with a BMU to determine the appropriate action for the item comprises:
iterating through each of the plurality of actions;
determining, for each of the N dimensions whether the row of measurements is within the range for association with the action;
if the row of measurements is within the range for association with the action, determining the distance between the row of measurements and every finished node, determining which finished node is closest to the row of measurements;
comparing the row of measurements to the threshold for association with the finished node each of the N dimensions; and
comparing the FMID of the row of measurements to the FMID threshold of the closest finished node;
if the row of measurements for the item is between the upper and lower threshold and the BMU in each of the N dimensions, and if the FMID of the row of measurements is between the FMID threshold of the closes finished node, then the selection controller assigning the closest finished node as the BMU for the row of measurements and initiating the action associated with the unique identifier BMU;
If the row of measurements is not within the range for association with the action, checking the next action;
if the row of measurements is not in within the range for association with action for any action, determining that a null action should be taken;

18. The method of claim 1, wherein, for each finished node, the selection controller is configured to present a user with an option for the selection controller to not consider one or more of the FMID threshold or one or more of the thresholds for association with the finished node in the N dimensions.

19. The method of claim 1, wherein the FM is a self-organizing feature map (SOFM).

20. The method of claim 1, wherein the selection controller is configured to, when in use, record the determined action for each row of measurements.

21. The method of claim 1, wherein the method further comprises configuring the selection controller to, when in use to monitor the percentage of rows of measurements that are being associated with each finished node within a quantized time period; and
comparing the percentages to the percentages of rows of measurements assigned to each finished node during configuration.

22. The method of claim 1, wherein the selection controller is further configured to calibrate the conversion of scalar quantities.

23. A selection controller configured to implement the method of claim 1.
